(19) United States
(12) Patent Application Publication
(10) Pub. No.: US 2022/0143806 A1
(43) Pub. Date: May 12, 2022

(54) INSTALLER TOOL BAG

(71) Applicant: Juan Herrera, Seattle, WA (US)

(72) Inventor: Juan Herrera, Seattle, WA (US)

(21) Appl. No.: 17/091,896

(22) Filed: Nov. 6, 2020

(51) Int. Cl. B25H 3/00; A45F 5/02; A45C 13/02

(52) U.S. Cl. CPC B25H 3/00; A45F 2200/0575; A45C 13/02; A45F 5/021

(57) ABSTRACT

A tool bag comprising a base panel, a plurality of sidewalls, a bottom edge connected to the base panel, a first vertical edge and a second vertical edge, each of the sidewalls having an outer surface and an inner surface, a belt flap having a lower portion defining a first horizontal sidewall, the horizontal sidewall connected to the base panel and mounted perpendicular to the first vertical edge on each of the plurality of sidewalls, a removable cover slidably inserted into a vertical groove on the second vertical edge on each of the plurality of sidewalls, the removable cover when inserted forming a second horizontal sidewall, and a third horizontal wall connected to the inner surface on each of the plurality of sidewalls and inserted between the belt flap defining the first horizontal sidewall and the removable cover defining the second horizontal sidewall.

### FIELD

The present disclosure relates generally to the field of utilitarian work goods and, in particular but not exclusively, relates to an installer tool bag for holding work tools and other goods enabling the single-handed removal of sections of adhesive material from an internal support structure.

### BACKGROUND

A wide variety of workmen, mechanics and craftsmen often have a need to carry multiple tools and supplies to handle complex work tasks. As workmen, graphic installers in particular frequently face challenges limiting their ability to gain access to important supplies such as adhesive tapes. In their work, graphic installers must often climb onto or move around large structures in awkward positions that do not permit them to carry or to use certain tools or supplies efficiently. Indeed, many workers must often leave large sections of graphic materials unattended while atop a complex structure such as a bus, a billboard, etc. in order to access important supplies like adhesives in order to mount such graphic materials onto these structures. As a result, an increased likelihood of misalignment of graphical materials may and frequently does occur which in turn creates an additional loss of time and an expenditure of added effort in removing and re-aligning these materials.

Current tool bags are of limited value when used in a manner required by graphic installers and other workmen who must work with large sections of materials that is to be applied over large surface areas. Such tool bags require that workmen either maintain contact with materials that are to be applied to a surface, often with one hand or an elbow or foot, or to place an object of sufficient weight onto the applied material to hold in place while adhesives or other materials are applied to secure the material onto the surface or object. The tool bags provide more limited pouches for receiving tools of different sizes and, more importantly, often provide insufficient space for receiving, containing, and permitting adhesives to be withdrawn, detached and applied with the use of only a single hand. This is a critical limitation in the absence of which has increased work time on projects, increased the potential for the loss of tools or tool bags while workers are atop large structures, and is more generally inconvenient.

Thus, there is a significant and growing need for an installer's tool bag that is large enough to receive tools of different sizes and to also permit the receipt of adhesive tapes of varying sizes that enable the removal and detachment of sections of tape of user-determined lengths with a single hand to reduce overall project work time, increase personal safety and to increase worker productivity.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1A is a perspective view of an installer tool bag in an embodiment.

FIG. 1B is a perspective view of an installer tool bag illustrating a compartment for receiving an adhesive tape roll in an embodiment.

FIG. 2 is a perspective view of an installer tool bag including multiple pockets for receiving tools in an embodiment.

### DESCRIPTION

In the description to follow, various aspects of embodiments will be described, and specific configurations will be set forth. These embodiments, however, may be practiced with only some or all aspects, and/or without some of these specific details. In other instances, well-known features are omitted or simplified in order not to obscure important aspects of the embodiments.

Various operations will be described as multiple discrete steps in turn, in a manner that is most helpful in understanding each disclosed embodiment; however, the order of description should not be construed as to imply that these operations are necessarily order dependent. These operations need not be performed in the order of presentation.

The description repeatedly uses the phrases “in one embodiment”, which ordinarily does not refer to the same embodiment, although it may. The terms “comprising”, “including”, “having”, and the like, as used in the present disclosure are synonymous.

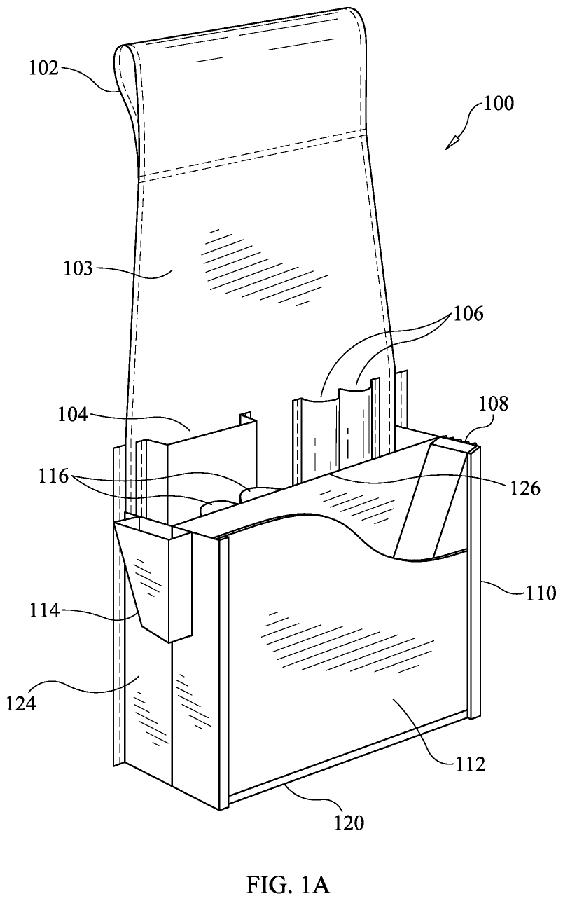

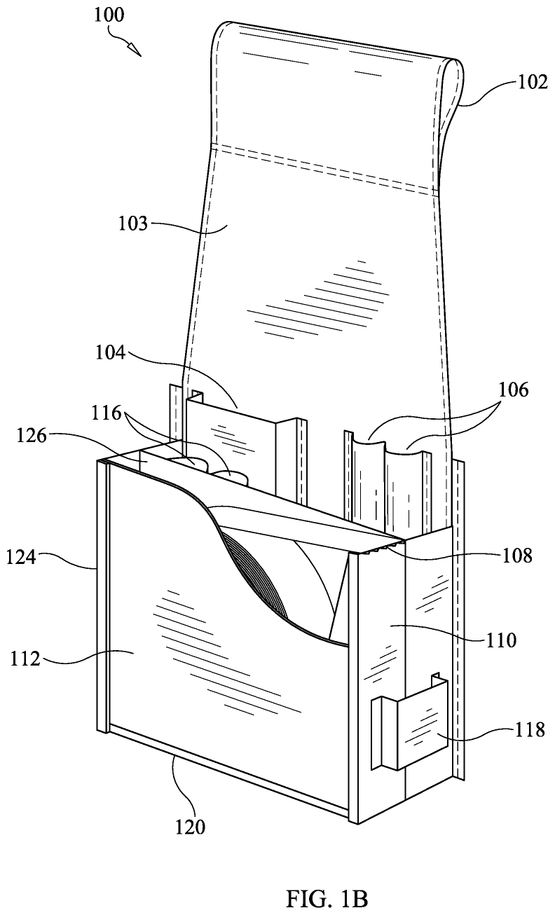

FIG. 1A is an illustration of an installer tool bag 100 in an embodiment. In this illustrated embodiment, the tool bag 100 includes a belt flap 103 that is used to form a horizontal sidewall of the tool bag 100 on its lower portion. The upper portion of the belt flap 103 is formed to define a belt loop 102 for receiving and stabilizing a workman's belt while the tool bag 100 is worn in a work environment. In one common and representative work environment, a workman must restrain certain materials on a structure (e.g., a building wall, bus, large commercial truck, or other sizeable structure) with one hand while accessing tools in the tool bag 100 or dispensing and removing tape or a different form of adhesive material from the tool bag 100 for use in securing the materials onto the structure. In placing such materials, often the workman's position can be horizontal, vertical or an alternative diagonal orientation relative to the point of placement of the materials. Thus, it is important for the tool bag 100 to be readily accessible stabilized close to the workman as is made possible with the belt loop 102.

A lower portion of the belt flap 103 is connected to a base panel 120, a first vertical sidewall 110 and a second vertical sidewall 124 which collectively define a plurality of compartments for receiving various accessories and tools used by a workman or specialist such as a graphic materials installer. A horizontal interior wall 126 extending horizontally between the inner surfaces of the first vertical sidewall 110 and the second vertical sidewall 124 defines a first inner compartment and a second outer compartment. The horizontal interior wall 126 is connected perpendicular to the inner surface of the first vertical sidewall 110 and the second vertical sidewall 124, and the horizontal wall 126 having an inner surface and an outer surface for separating two distinct spatial compartments. The inner surface of the horizontal interior wall 126, the lower portion of the belt flap 103 and the inner portions of the first sidewall 110 and the second sidewall 124 closest to the lower portion of the belt flap 103 form the first inner compartment. The outer surface of the horizontal interior wall 126, the outer portions of the first sidewall 110 and the second sidewall 124 farthest from the lower portion of the belt flap 103, and a removable outer cover 112 define the second outer compartment.

In one embodiment, a vertically oriented guide channel formed from a couple of raised guide-arms is provided adjacent to the outer portions of each of the vertical sidewalls 110, 124 for the insertion and removal of the removable outer cover 112. In an alternative embodiment, an internal guide channel or vertically-oriented groove is provided on each inner surface and adjacent to the outer edge of the first sidewall 110 and the second sidewall 124 for the insertion and removal of the removable outer cover 112. Upon insertion, the removable outer cover 112, in addition to being held in place by either the vertically oriented guide channel or the internal guide channel on the first sidewall 110 and the second sidewall 124, is secured in place in a groove channel near the outer edge of the base panel 120. In this embodiment, the removable outer cover 112 can be slidably inserted and held in place regardless of the position or orientation of a workman with respect to a graphic panel or other sheet or covering requiring the use of at least one hand to hold the panel, sheet or covering in place while a workman attempts to extract and separate suitable lengths of tape or other adhesive from the tool bag 100. In alternative embodiments other suitable holding or restraint means can be used on the inner surface of the base panel 120 to receive and hold the removable outer cover 112 in place while the tool bag 100 is worn or used by a workman in conjunction with the guide channels or groove channels discussed previously on the vertical sidewalls 110, 124.

The first inner compartment of the tool bag 100 is comprised of multiple sub-compartments in different configurations. These sub-compartments are used to receive and hold various tools used by a workman. In the illustrated embodiment, a slot 104 attached is the lower portion of the belt flap 103 is provided to hold a workmen's level and a plurality of knife pockets 106 also connected to the lower portion of the belt flap 103 are provided for receiving and holding small workmen's cutting knives. On the inner surface of the horizontal interior wall 126, a plurality of pen pockets 116 are provided for receiving and holding writing pens which may be useful to workmen, especially graphic installers.

The second outer compartment of the installer tool bag 100 includes a holder for a mounted roll of tape that can be dispensed and cut with the use of a tape cutting blade 108 placed on the upper edge of the first vertical sidewall 110. The removable outer cover 112 is shown inserted between the first vertical sidewall 110 and the second vertical sidewall 124 as a means of defining the second outer compartment. A scissor pocket 114 is shown attached to the second vertical sidewall 124 and used for receiving and holding a workman's pair of scissors. In one embodiment, the scissor pocket 114 is connected to a vertical sidewall using conventional mounting means such as an adhesive glue or small coupling screws. In an alternative embodiment, the scissor pocket 114 is formed as part of the second vertical sidewall 114 using injection molding processes or other related industrial forming processes.

FIG. 1B illustrates an opposing view of an installer tool bag 100 in an embodiment. In this illustrated view, on the outer surface of the horizontal interior wall 126 is mounted a tape holding cylinder 122 (not shown) which lies within the second outer compartment referred as the tape dispenser compartment. The tape holding cylinder 122 in the tape dispenser compartment is used to mount and hold a roll of adhesive tape, as illustrated in this figure, or other rolled materials, that can be withdrawn and cut into sections on a tape cutting blade 108 placed on or embedded in the first vertical sidewall 110 in an embodiment. In practice, an edge of the adhesive tape is located, and the tape is then extended and placed onto the tape cutting blade 108 on the upper edge of the first vertical sidewall 110. Once extended to the desired length, the tape is separated into a section or multiple sections of desired length using only a single hand by applying downward pressure at the line of the desired length on the tape using the tape cutting blade 108.

In addition to a tape cutting blade 108, a tape measure holder 118 is connected to the first vertical sidewall 110 for use in securely holding a tape measure for use by a workman. In the case of graphic installers, a tape measure is often used to measure the lengths of graphic prints or other materials that are to be applied to structure. Often it is important to have a restraint on an end of a tape measure since installers frequently must hold or restrain graphic print materials with one hand while measuring their length with the other free hand. A tape measure holder 118 is the restraint that can be used to hold a tape measure while it is extended over an object or other graphic print material for measurement purposes. Likewise, the tape measure can be readily retracted simply be releasing the end of the tape measure that is held by the one free hand. In one embodiment, the tape measure holder 118 is a metal slot and is connected to the first vertical sidewall 110 using conventional mounting means such as an adhesive glue or small coupling screws. In an alternative embodiment, the tape measure holder 118 is formed as part of the first vertical sidewall 114 using injection molding processes, thermoforming process or other related industrial plastic forming processes.

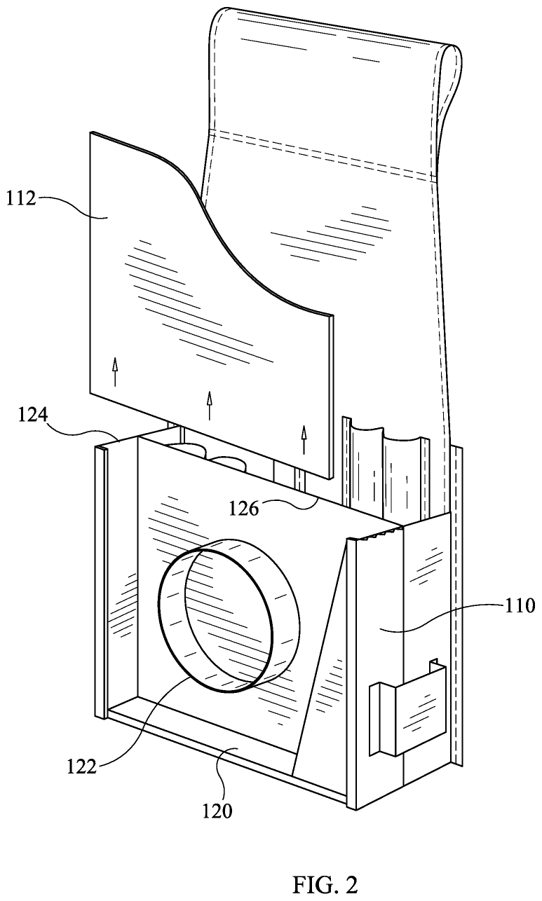

In terms of material composition, in one embodiment, the tool bag 100 is formed from a combination of durable plastic and leather. In the embodiment illustrated in FIGS. 1A-2, the belt flap 103 is formed in one embodiment of leather and in an alternative embodiment from a canvas material sandwiched between a rear layer of polyvinyl chloride (PVC) layer and a frontal layer of PVC. The vertical sidewalls 110, 124, the base panel 120, the horizontal interior wall 126, the removable outer cover 112 and the tape holding cylinder 122 are formed and comprised of a thermoplastic material. The belt flat 103 is attached to the base panel 120, and the first vertical sidewall 110 and the second vertical sidewall 124 using a resin or other common bonding solution. In alternative embodiments, the materials used to form these structures include glass loaded nylon, thermoplastic polyurethane (TPU), or other suitable composite materials capable of being held together using resins or other material compounds for the binding of the compartments to the belt flap 103.

FIG. 2 is an illustration of the second outer compartment of an installer tool bag 100 in an embodiment. In this illustrated embodiment, the removable outer cover 112 has been raised out of the second outer compartment to reveal the tape holding cylinder 122 mounted on the outer surface of the horizontal interior wall 126. In practice, a workman will raise and lower the removable outer cover 122 as necessary to insert a new or replacement roll of tape onto the cylinder 122. This compartment also serves as a tape guide region to enable the tape to be dispensed in one direction toward the tape cutting blade 108 on the upper portion of the first vertical sidewall 110. The first vertical sidewall 110 and the second vertical sidewall 124 are shown in this embodiment with raised outer edges for use as a guide when inserting the removable outer cover 112. Although a single raised edge is shown on each of these illustrated edges of the first vertical sidewall 110 and the second vertical sidewall 124, in an alternative embodiment, a raised guide channel with parallel extensions is provided on the edge of each vertical sidewall 110, 124 for the insertion and removal of the removable outer cover 112. In yet a different embodiment, an internal guide channel is provided for the insertion and removal of the removable outer cover 112.

Although specific embodiments have been illustrated and described herein, it will be appreciated by those of ordinary skill in the art that a wide variety of alternate and/or equivalent implementations may be substituted for the specific embodiments shown and described without departing from the scope of the present disclosure. This application is intended to cover any adaptations or variations of the embodiments discussed herein.

What I claim is:

1. A tool bag for carrying a workmen's tools, comprising:
a base panel;
a plurality of sidewalls each having a top edge, a bottom edge connected to the base panel, a first vertical edge and a second vertical edge, each of the sidewalls having an outer surface and an inner surface;
a belt flap having a lower portion defining a first horizontal sidewall, the horizontal sidewall connected to the base panel and mounted perpendicular to the first vertical edge on each of the plurality of sidewalls;
a removable cover slidably inserted into a vertically oriented guide channel adjacent to the second vertical edge on each of the plurality of sidewalls, the removable cover when inserted forming a second horizontal sidewall; and
a third horizontal wall connected to the inner surface on each of the plurality of sidewalls and inserted between the belt flap defining the first horizontal sidewall and the removable cover defining the second horizontal sidewall, the third horizontal wall having an inner surface and an outer surface;
wherein the plurality of sidewalls, the belt flap defining the first horizontal sidewall and the inner surface of the third horizontal wall define a first tool compartment, and wherein the plurality of sidewalls, the inserted removable cover and the outer surface of the third horizontal wall define a second tool compartment.

2. The tool bag of claim 1 wherein the outer surface of the third horizontal wall includes a tape holding cylinder mounted thereon for holding a roll of dispensing tape.

3. The tool bag of claim 1 further comprising a tape cutting blade located on the top edge of one of the plurality of sidewalls defining the second tool compartment.

4. The tool bag of claim 3 wherein the tape cutting blade is configured to cut tape dispensed with a single hand from a tape roll located on a tape roll holder mounted on the outer surface of the third horizontal wall.

5. The tool bag of claim 1 further comprising a pocket for holding a pair of scissors, the pocket located on the outer surface of one of the plurality of sidewalls.

6. The tool bag of claim 1 further comprising a holder for receiving a tape measure, the holder located on the outer surface of one of the plurality of sidewalls.

7. The tool bag of claim 1 wherein the first horizontal sidewall includes a first mounted pocket and a plurality of shortened receiving pockets, the first mounted pocket configured for holding a workman's level and each of the plurality of shortened receiving pockets configured for holding a workman's knife.

8. The tool bag of claim 1 wherein the third horizontal wall includes on the inner surface a plurality of pockets for holding writing pens.

9. The tool bag of claim 1 wherein the belt flap further comprises an upper portion defining a belt loop for receiving and holding a belt.

10. The tool bag of claim 5 wherein the pocket is located on the outer surface using an injection molding process.

11. The tool bag of claim 5 wherein the pocket is located on the outer surface using an adhesive glue or a plurality of coupling screws.

12. The tool bag of claim 6 wherein the holder is comprised of plastic and is located on the outer surface of the sidewall using an injection molding process or a thermoforming process.

13. The tool bag of claim 6 wherein the holder is comprised of metal and is located on the outer surface of the sidewall using an adhesive glue or a plurality of coupling screws.

14. The tool bag of claim 1 wherein the removable cover is inserted into an internal guide channel on the inner surface of each of the plurality of sidewalls, the internal guide channel adjacent to the second vertical edge on each of the plurality of sidewalls, the removable cover when inserted forming the second horizontal sidewall.
